(19) United States
(12) Patent Application Publication
(10) Pub. No.: US 2007/0168978 A1
(43) Pub. Date: Jul. 19, 2007

(54) Computer program code debugging method and system

(75) Inventor: Yi-Tsun Lu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/312,991

(22) Filed: Dec. 19, 2005

(51) Int. Cl. G06F 9/44

(52) U.S. Cl. 717/124

(57) ABSTRACT

A computer program code debugging method and system is proposed, which is designed for use in conjunction with a computer platform for providing a user-operated computer program code debugging function on a faulty computer program such as a BIOS program; and which is characterized by the capability of automatically collecting all the constituent routines of a faulty computer program and computing for the runtime address of these routines so that the user can utilize the runtime breakpoint address of the faulty program as a keyword to find the problem-causing routine that contains the breakpoint address and thereupon can focus the debugging process solely on that routine rather on the entire program. This feature allows software engineers to more conveniently and efficiently debug a faulty computer program.

### BACKGROUND OF THE INVENTION

1. Field of the Invention

This invention relates to information technology (IT), and more particularly, to a computer program code debugging method and system which is designed for use with a computer platform for providing a user-operated computer program code debugging function that can assist the user (i.e., software engineer) to more conveniently and efficiently debug the erroneous code in a faulty computer program, such as a BIOS (Basic Input/Output System) program.

2. Description of Related Art

In the development of computer programs, such as BIOS (Basic Input/Output System) programs, each developed BIOS program should undergo a testing procedure before being publicly released for use. During the testing procedure, a computer platform is used to run the BIOS program to see if the BIOS program can operate normally to provide the intended functionality without causing abnormal operating conditions or system crash. If the BIOS program causes abnormal operating condition or system crash, the software engineers need to carry out a debugging process to find and correct the erroneous code in the faulty BIOS program.

Breakpoint debugging method is a widely used method for debugging a faulty BIOS program, by which a breakpoint (i.e., an instruction that will halt the program when being executed) is set by the software engineer somewhere in the BIOS program where the software engineer thinks that the erroneous code might reside. When the BIOS program is set to run on the computer platform, it will be halted when the breakpoint instruction is executed, and whereupon the software engineer can check all variable and register values at the breakpoint to find what might have caused the abnormal operating condition.

One drawback to the foregoing breakpoint debugging method, however, is that it requires the software engineer to manually collect all the routines included in the faulty BIOS program from the *.MAP (Link Editor Map) files that are generated during the compilation of the BIOS program during runtime and then find the runtime addresses of these routines (where the address is represented in terms of segment and offset), and is therefore quite tedious, laborious, and timing-consuming. In addition, the breakpoint debugging method requires the software engineer to focus the debugging process on the entire range of the faulty BIOS program, and therefore is quite inefficient.

Another BIOS debugging method widely utilized in the information industry is to visually inspect a specific set of indictor lamps on the motherboard when an abnormal operating condition occurs to the BIOS program, for example the Port 84 and Port 85 indictor lamps on the BIOS chip, for the purpose of determining the possible location of the erroneous code. One drawback to this practice, however, is that it is significantly inaccurate to allow the software engineer to pinpoint the exact location of the erroneous code.

Still another BIOS debugging method widely utilized in the information industry is to insert some testing instructions at some specific locations in the faulty BIOS program where the erroneous code might reside, run the program, and check the results of the execution of these testing instructions to determine what might be wrong in the logic of the program code. After the erroneous code has been corrected, these testing instructions are removed from the BIOS program. One drawback to this method, however, is that the overall process of the adding, execution, result inspection, and removing of these testing instructions is also quite tedious, laborious, and timing-consuming and is therefore still an inefficient method for debugging a faulty BIOS program.

### SUMMARY OF THE INVENTION

It is therefore an objective of this invention to provide a computer program code debugging method and system which can help allow software engineers to more conveniently and efficiently debug a faulty BIOS program.

The computer program code debugging method and system according to the invention is designed for use with a computer platform for providing a user-operated computer program code debugging function that can assist the user (i.e., software engineer) to more conveniently and efficiently debug the erroneous code in a faulty computer program, such as a BIOS (Basic Input/Output System) program.

The computer program code debugging method according to the invention comprises: (1) collecting all the constituent runtime routines of the faulty computer program, and displaying all these routines in a user-perceivable form on the computer platform; (2) computing for the runtime address of each of the constituent routines of the faulty computer program, and displaying the computed address values in a user-perceivable form on the computer platform; (3) responding to a user-inputted breakpoint address of the faulty computer program by finding the corresponding breakpoint-containing routine from the constituent routines of the faulty computer program; and (4) performing a debugging process on the breakpoint-containing routine to obtain a bug-free computer program.

In terms of modularized architecture, the computer program code debugging system according to the invention comprises: (a) a user interface module, which is used to provide an on-screen user interface on the computer platform for user interaction with the computer program code debugging system; (b) a routine collecting module, which is capable of collecting all the constituent runtime routines of the faulty computer program and displaying all these routines through the user interface module on the computer platform; (c) a runtime-address computing module, which is capable of computing for the runtime address of each of the constituent routines of the faulty computer program collected by the routine collecting module, and displaying the computed address values through the user interface module on the computer platform; (d) a query module, which is capable of providing a user-operated query function through the user interface module, and which is capable of responding to a user-inputted breakpoint address of the faulty computer program by finding the corresponding breakpoint-containing routine; and (e) a debugging module, which is capable of providing a user-operated debugging procedure for debugging the breakpoint-containing routine found by the query module.

The computer program code debugging method and system according to the invention is characterized by the capability of automatically collecting all the constituent routines of a faulty computer program and computing for the runtime address of these routines so that the user can utilize the runtime breakpoint address of the faulty program as a keyword to find the problem-causing routine that contains the breakpoint address and thereupon can focus the debugging process solely on that routine rather on the entire program. This feature allows software engineers to more conveniently and efficiently debug a faulty computer program.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and architecture of the computer program code debugging system according to the invention; and

FIG. 2 is a schematic diagram showing an example of an on-screen user interface utilized by the computer program code debugging system of the invention.

### DETAILED DESCRIPTION OF PREFERRED EMBODIMENTS

The computer program code debugging method and system according to the invention is disclosed in full details by way of preferred embodiments in the following with reference to the accompanying drawings.

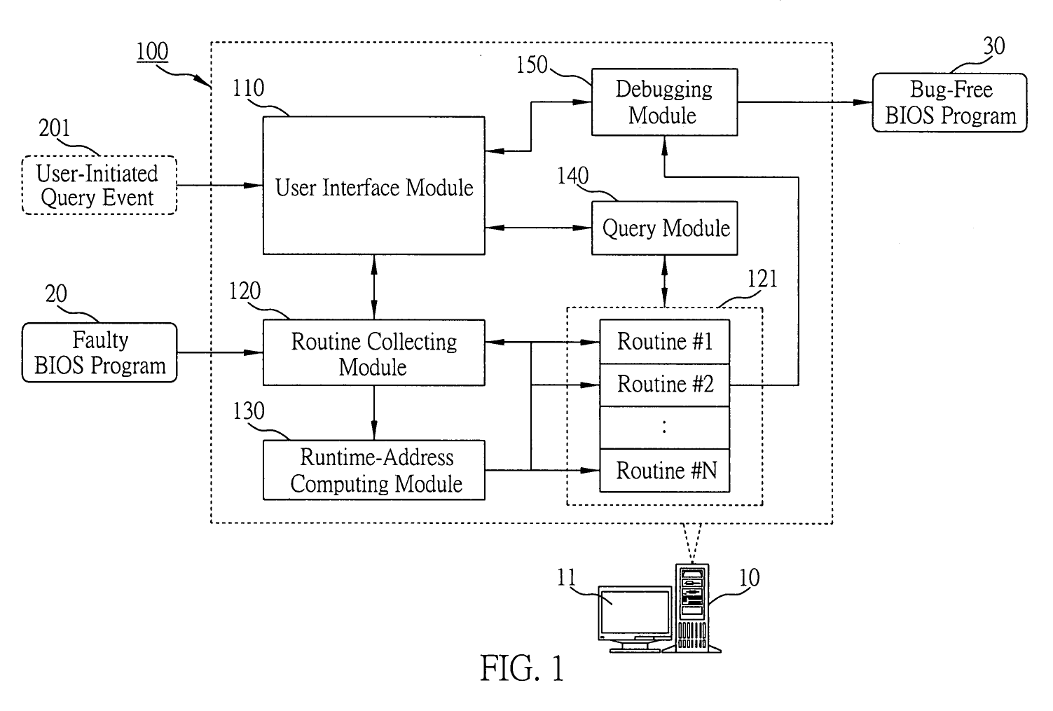

FIG. 1 is a schematic diagram showing the application and architecture of the computer program code debugging system according to the invention (as the part enclosed in the dotted box indicated by the reference numeral 100). As shown, the computer program code debugging system of the invention 100 is designed for use with a computer platform 10, such as a desktop computer or a server, for providing a user-operated computer program code debugging function that can assist the user (i.e., software engineer) to more conveniently and efficiently locate the erroneous code in a computer program, such as a BIOS (Basic Input/Output System) program 20, in the event that the BIOS program 20 fails to run properly on the computer platform 10.

As shown in FIG. 1, the modularized object-oriented component model of the computer program code debugging system of the invention 100 comprises: (a) a user interface module 110; (b) a routine collecting module 120; (c) a runtime-address computing module 130; (d) a query module 140; and (e) a debugging module 150.

Firstly, the respective attributes and behaviors of the constituent modules 110, 120, 130,140,150 of the computer program code debugging system of the invention 100 are described in details in the following.

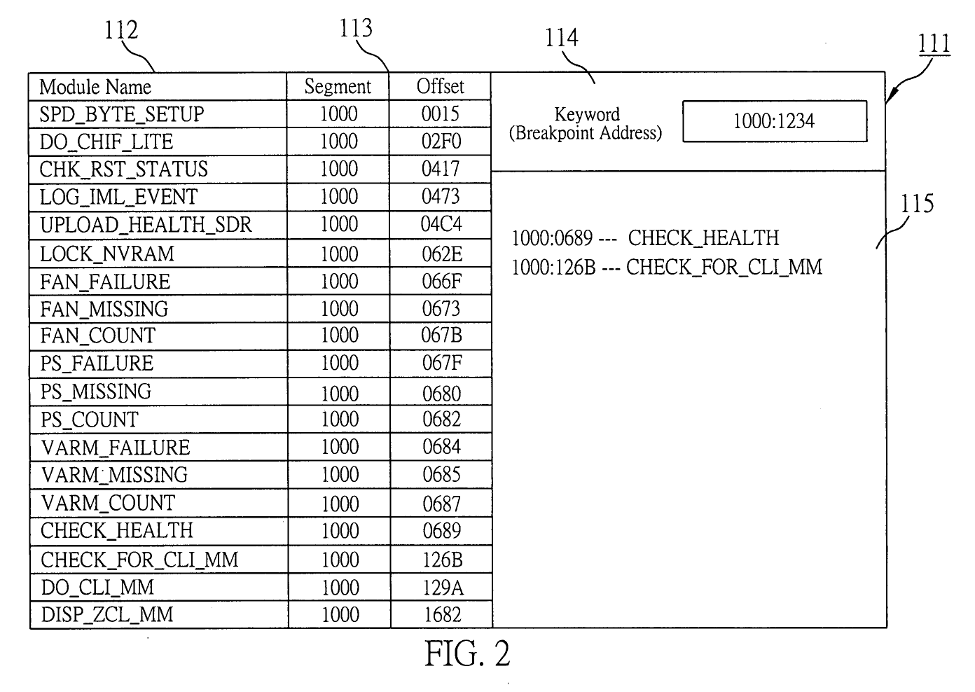

The user interface module 110 is used to provide an on-screen user interface 111 shown in FIG. 2 and display it on the screen 11 of the computer platform 10 for the user (i.e., software engineer) to interact with the computer program code debugging system of the invention 100 (it is to be noted that the on-screen user interface 111 shown in FIG. 2 is only an example of the embodiment of the invention, which can have various other different designs and include various other controls and options). As shown in FIG. 2, the on-screen user interface 111 includes a routine display area 112, a runtime-address display area 113, a keyword input area 114, and a query result display area 115; wherein the routine display area 112 is used to display the names of all the constituent routines (or called “modules” or “procedures”) of the BIOS program 20; the runtime-address display area 113 is used to display the runtime address (represented by segment and offset) of each of the routines included in the BIOS program 20; the keyword input area 114 is for use by the software engineer to manually input the value of the breakpoint address where the BIOS program 20 is halted due to erroneous code therein; and the query result display area 115 is used to display the result of the query based on the user-inputted breakpoint address received by the keyword input area 114, where the query result shows the name and runtime-address range of the routine that contains the breakpoint address during runtime.

The routine collecting module 120 is capable of collecting all the constituent routines of the faulty BIOS program 20 into a collection 121, and activating the user interface module 110 to display all the collected routines 121 in a user-perceivable form through the routine display area 112 of the on-screen user interface 111 displayed on the screen 11 of the computer platform 10 as illustrated in FIG. 2 for browsing by the user.

The runtime-address computing module 130 is capable of computing for the runtime address where each of the routines collected by the routine collecting module 120 is actually executed during runtime on the computer platform 10. In practical implementation, for example, each address is represented by segment and offset. During actual operation, the user interface module 110 will responsively display the computed runtime address values outputted from the runtime-address computing module 130 through the runtime-address display area 113 of the on-screen user interface 111 shown in FIG. 2.

The query module 140 is used to provide a user-operated breakpoint-containing routine query function that is capable of responding to a user-initiated query event 201 (i.e., an event of the user inputting the value of the breakpoint address at which the faulty BIOS program 20 is halted during runtime) through the keyword input area 114 to be used as a keyword) by retrieving the corresponding breakpoint-containing routine from the collection of constituent routines 121 of the faulty BIOS program 20 collected by the routine collecting module 120, and then displaying the query result through the query result display area 115 of the on-screen user interface 111 shown in FIG. 2. In practical implementation, for example, the value of the breakpoint address can be obtained by using a conventional ITP (In-Target Probe) device or other equivalent devices. In addition, the query module 140 further includes a call-originating routine query function that allows the user to inquire for the call-originating routine that calls the breakpoint-containing routine during runtime. This call-originating routine query function can be realized by using, for example, the CALL, JSB, ROM Gate utilities available in most BIOS programming languages.

The debugging module 150 is used to provide a user-operated debugging function that allows the user (i.e., software engineer) to debug the faulty BIOS program 20 by focusing solely on the breakpoint-containing routine reported by the query module 140. With the debugging module 150, the software engineer can utilize various conventional methods for debugging the faulty routine in the BIOS program 20, for example, by setting a user-specified breakpoint in the problem-causing routine in the faulty BIOS program 20, modify the instructions in the problem-causing routine, and so on, with the end purpose of obtaining a bug-free BIOS program 30.

The following is an example of a practical application of the computer program code debugging system of the invention 100 in actual utilization by a user. In this application example, it is assumed that the BIOS program 20 is composed of a number of routines whose names are shown in the routine display area 112 shown in FIG. 2, and wherein the routine named “CHECK_HEALTH” contains a bug that causes the BIOS program 20 to operate abnormally during runtime. With the help of the invention, the user (i.e., software engineer) is able to quickly find that the bug resides in the routine “CHECK_HEALTH” and therefore focus the debugging process solely on the routine “CHECK_HEALTH”.

Referring to FIG. 1 together with FIG. 2, when the newly-developed BIOS program 20 causes an abnormal operating condition during runtime on the computer platform 10, the software engineer can then start the computer program code debugging system of the invention 100 to perform a debugging process on the faulty BIOS program 20. The computer program code debugging system of the invention 100 will first activate the user interface module 110 to display an on-screen user interface 111 on the screen 11 of the computer platform 10 as shown in FIG. 2, and meanwhile activate the routine collecting module 120 to collect all the constituent routines of the BIOS program 20 into a collection of runtime routines 121. Next, the runtime-address computing module 130 is activated to compute for the value of the runtime address of each of the constituent routines of the faulty BIOS program 20 where each routine is actually executed during runtime on the computer platform 10. The user interface module 110 then display the names of all the constituent routines of the faulty BIOS program 20 through the routine display area 112 and their runtime address ranges through the runtime-address display area 113 of the on-screen user interface 111. This allows the user to browse all the constituent routines of the faulty BIOS program 20 and their runtime address ranges all through the on-screen user interface 111.

At this point, the software engineer can input the address of the runtime breakpoint of the faulty BIOS program 20 through the keyword input area 114 of the on-screen user interface 111 to initiate a user-initiated query event 201. In this example, it is assumed that the faulty BIOS program 20 is halted during runtime at the address [1000:1234]. In this case, the software engineer can input this address value [1000:1234] into the keyword input area 114. This will cause the query module 140 to respond to the user-initiated query event 201 by retrieving the breakpoint-containing routine (i.e., the “CHECK_HEALTH” routine”, and displaying the query result through the query result display area 115 of the on-screen user interface 111 to the user. In the example of FIG. 2, the query result display area 115 shows the name “CHECK_HEALTH” of the breakpoint-containing routine and its starting address [1000:0689] during runtime, where [1000] represents the segment number and [0689] represents the offset value. If necessary, the software engineer can further utilize the query module 140 to inquire for the call-originating routine that calls the breakpoint-containing routine “CHECK_HEALTH” during runtime by using CALL, JSB, ROM Gate utilities from the BIOS programming language, for the purpose of identifying the call-originating routine that calls the breakpoint-containing routine “CHECK_HEALTH” during runtime, so that the debugging process can be traced back to the call-originating routine.

As the software engineer knows which routine causes the BIOS program 20 to operate abnormally (in this example, the routine named “CHECK_HEALTH”), the software engineer can then activate the debugging module 150 to perform a debugging process solely on the problem-causing routine “CHECK_HEALTH”. With the debugging module 150, the software engineer can utilize various conventional methods for debugging the routine “CHECK_HEALTH”, for example, by setting a user-specified breakpoint in this routine, modify the instructions in this routine, and so on, with the end purpose of obtaining a bug-free BIOS program 30.

In conclusion, the invention provides a computer program code debugging method and system for use with a computer platform for providing a user-operated computer program code debugging function; and which is characterized by the capability of automatically collecting all the constituent routines of a faulty computer program and computing for the runtime address of these routines so that the user can utilize the runtime breakpoint address of the faulty program as a keyword to find the problem-causing routine that contains the breakpoint address and thereupon can focus the debugging process solely on that routine rather on the entire program. This feature allows software engineers to more conveniently and efficiently debug a faulty computer program. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer program code debugging method for use on a computer platform for providing a user-operated computer program code debugging function on a faulty computer program;
the computer program code debugging method comprising:
collecting all the constituent runtime routines of the faulty computer program, and displaying all these routines in a user-perceivable form on the computer platform;
computing for the runtime address of each of the constituent routines of the faulty computer program, and displaying the computed address values in a user-perceivable form on the computer platform;
responding to a user-inputted breakpoint address of the faulty computer program by finding the corresponding breakpoint-containing routine from the constituent routines of the faulty computer program; and
performing a debugging process on the breakpoint-containing routine to obtain a bug-free computer program.

2. The computer program code debugging method of claim 1, wherein the computer program is a BIOS (Basic Input/Output System) program.

3. The computer program code debugging method of claim 1, further comprising:
performing a call-originating routine query procedure to finding a call-originating routine that calls the breakpoint-containing routine during runtime

4. The computer program code debugging method of claim 1, wherein the breakpoint address value is obtained by using an ITP (In-Target Probe) device.

5. A computer program code debugging system for use with a computer platform for providing a user-operated computer program code debugging function on a faulty computer program;
the computer program code debugging system comprising:
a user interface module, which is used to provide an on-screen user interface on the computer platform for user interaction with the computer program code debugging system;
a routine collecting module, which is capable of collecting all the constituent runtime routines of the faulty computer program and displaying all these routines through the user interface module on the computer platform;
a runtime-address computing module, which is capable of computing for the runtime address of each of the constituent routines of the faulty computer program collected by the routine collecting module, and displaying the computed address values through the user interface module on the computer platform;
a query module, which is capable of providing a user-operated query function through the user interface module, and which is capable of responding to a user-inputted breakpoint address of the faulty computer program by finding the corresponding breakpoint-containing routine; and
a debugging module, which is capable of providing a user-operated debugging procedure for debugging the breakpoint-containing routine found by the query module.

6. The computer program code debugging system of claim 5, wherein the computer program is a BIOS (Basic Input/Output System) program.

7. The computer program code debugging system of claim 5, wherein the query module further includes a call-originating routine query function for finding a call-originating routine that calls the breakpoint-containing routine during runtime.

8. The computer program code debugging system of claim 5, wherein the breakpoint address value is obtained by using an ITP (In-Target Probe) device.
